(19) United States
(12) Patent Application Publication
(10) Pub. No.: US 2004/0061770 A1
(43) Pub. Date: Apr. 1, 2004

(54) Imaging head with pigtailed laser diodes and micromachined light-pipe and arrays thereof

(76) Inventors: Nissim Pilossof, Rehovot (IL); Igal Koifman, Hadera (IL); Alex Weiss, Kadima (IL)

Correspondence Address: Eitan Pearl Latzer & Cohen Zedek, Suite 1001, 10 Rockefeller Plaza, New York, NY, 10020, US

(21) Appl. No.: 10/451,801

(22) PCT Filed: Nov. 18, 2001
(86) PCT No.: PCT/IL01/01062

(51) Int. Cl. B41J 2/45

(52) U.S. Cl. 347/238

(57) ABSTRACT

An optical imaging heads that produce a plurality of light spots on light sensitive medium such as photographic film or printing plate. The optical head incorporates an array of multi-mode laser diodes optically coupled to multi-mode optical fibers, an array of micromachined supports for the optical fibers, an array of micromachined light-pipes (MLPs) aligned with the supports and with the optical fibers and means for imaging the exit aperture of each of the micromachined light-pipes on a photosensitive medium.

### FIELD OF THE INVENTION

The present invention relates to optical imaging heads that produce a plurality of light spots on light sensitive medium such as photographic film or printing plate. The optical head incorporates as light source, an array of pigtailed laser diodes and a Micro Light-Pipe Array (MLPA) as a beam-shaping element.

### BACKGROUND OF THE INVENTION

Optical heads for imaging a plurality of light spots on a light sensitive medium often incorporate, as a light source, an array of pigtailed Laser Diodes (LD). Each LD is optically coupled to one end of an Optical Fiber (OF). The opposite ends of the OFs are supported in a linear array by means such as V-groove plates, as illustrated in FIG. 1. The upper and lower V-groove plates, 11 and 17 respectively, are often made by a photolithographic procedure on Si, the V-grooves 19 being etched along [111] crystallographic plane in a very tight mechanical tolerance with the fibers' 18 cladding dimensions.

The imaging speed in electro-optical plotters is generally limited by the power delivered by the laser beam(s) to the medium. This is especially true when the imaged medium is a thermal printing plate, where the sensitivity is typically of the order of several hundred mJ/cm². In this case, the fiber-coupled diodes engaged in the array have to be powerful multi-mode LDs coupled to a multi-mode optical fiber, such as SDL-2300 manufactured by SDL Inc., of San Jose, Calif. An important characteristic of any fiber-coupled LD is the light energy distribution in the fiber's far field. Because of the multi-mode LID and the usually short length of the multi-mode fiber, the near-field and the far-field energy distributions depend on the quality of the optical coupling, the LD junction temperature (i.e. modulation data flow), the bending along the fiber length, etc. As far as the image on the photosensitive medium is obtained by imaging either the near-field or the far-field of the fiber, this non-uniform and frequently changing energy distribution of the light emerging from the fiber's end often leads to unpredictable energy distribution in the writing spot and to undesired effects on the image.

A way of avoiding this effect is to use a controlled-angle diffuser as in EP 0992343 A1 to Presstek Inc. The diffuser introduces a scrambling in the angular energy distribution and thus smoothes it. This approach, however, can hardly correct non-symmetrical or doughnut-mode energy distributions.

The present invention discloses an apparatus and method which successfully solve the problems described above, by using a micromachined Light-Pipe or Light-Pipe Array (MLPA) for delivering the light from a multi-mode laser source, such as multi-mode optical fiber, to a very well defined spot on the photosensitive medium.

### BRIEF DESCRIPTION OF THE DRAWINGS

FIG. 1 is a schematic exploded isometric view of a conventional-art V-groove assembly for supporting an array of optical fibers;

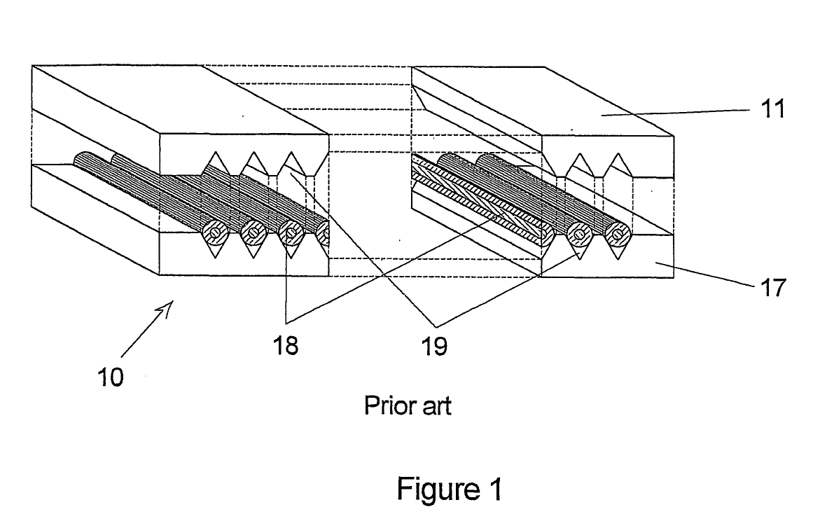

FIG. 2a is a schematic isometric view of an optical fiber aligned in a Micro Light-Pipe by means of a V-groove according to the present invention;

FIG. 2b is an exploded view of the assembly of FIG. 2a;

FIGS. 3a and 3b present the light energy distribution of a multi-mode optical fiber in the far field and in the exit apertures of a Micro Light-Pipe attached to it respectively;

FIG. 4 schematically illustrates an exemplary optical imaging head incorporating an optical fiber as a light source and a beam-shaping Micro Light-Pipe, according to the present invention;

FIG. 5 is a schematic isometric view of optical fibers aligned in an array by means of V-grooves and a Micro Light-Pipe array for beam shaping, according to the present invention;

FIG. 6 schematically illustrates an exemplary optical imaging head incorporating an optical-fiber array as multiple light source and beam-shaping by means of a Micro Light-pipe Array, according to the present invention; and

FIGS. 7a to 7d illustrate different channel shapes in Micro Light-Pipes.

### DETAILED DESCRIPTION OF PREFERRED EMBODIMENTS

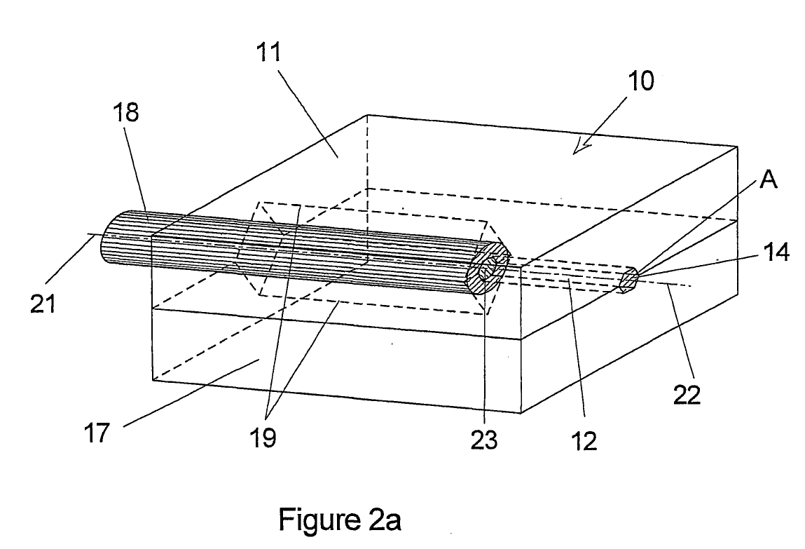

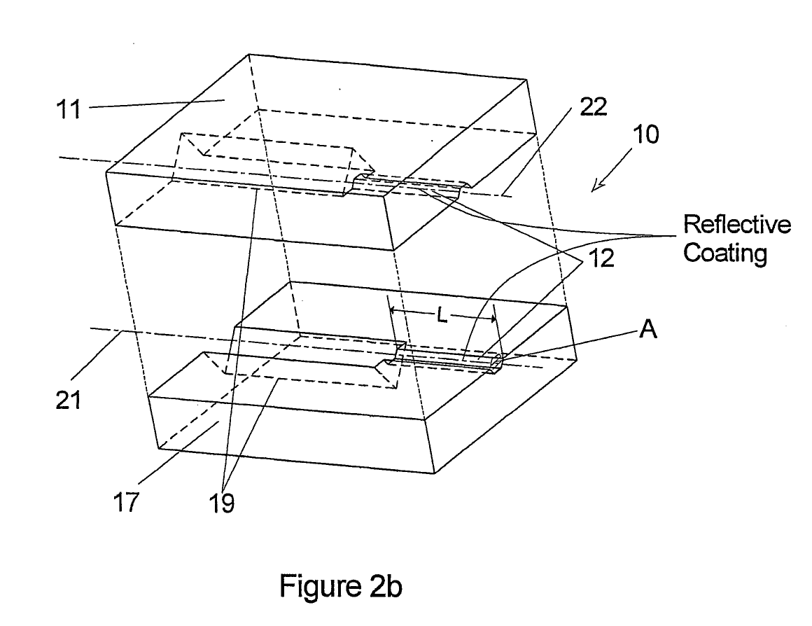

FIG. 2ashows a multi-mode optical fiber light source 18, with a supporting assembly 10 and a Micro Light-Pipe (MLP) 12. The V-groove 19 serves as a holder for the optical fiber 18, aligning its axis 21 to coincide approximately with the MLP axis 22. The V-groove—MLP assembly is made by upper part 11 and lower part 17, as shown in FIG. 2b. The MLP surface is coated with a highly reflective coating, such as Au, enhanced Al or dielectric, depending on the base material and the wavelength of the light.

The light emitted from the optical fiber 18 enters the micro light-pipe 12, where each beam experiences a number of reflections before it exits the light-pipe through its opposite side. Due to these multiple reflections, the illumination of the MLP exit aperture is relatively uniform. The uniformity, defined as

$$\frac{Edge Illumination}{Center Illumination} ,$$

is proportional to the value

$${L}_{n} = \frac{L \cdot {NA}_{i}}{\sqrt{A}} ,$$

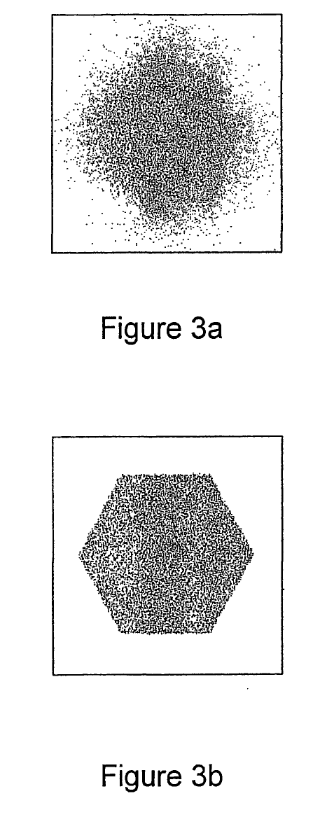

called normalized length, where L is the light-pipe length, NAᵢ is the input beam numerical aperture and A is the cross-sectional area of the micro light-pipe. There is no precise theory of light pipes. The scrambling efficiency is usually checked experimentally, or by non-sequential ray tracing. It is, however, an empirical fact that when Lₙ≧4, the illumination uniformity at the MLP exit can be expected to be better than 90%. The scrambling effect of the MLP of FIGS. 2a and 2b is illustrated in FIGS. 3a and 3b.

FIG. 3a shows a doughnut-mode far-field light distribution of a multi-mode LD coupled to a multi-mode fiber with 40μ core diameter. The micro light-pipe was chosen to have a hexagonal cross section, with A=1385 μ² (the fiber's core 23, FIG. 2a, is circumscribed in the MLP's aperture A) and with length L=0.5 mm.

FIG. 3b shows the scrambling effect of the MLP. The energy distribution at the exit aperture 14 is uniform, and as far as the this exit aperture will be imaged on the photosensitive medium, it is clear, that the resulting spot will also have uniform energy distribution, independently of the energy distribution of the light emerging from the fibers end.

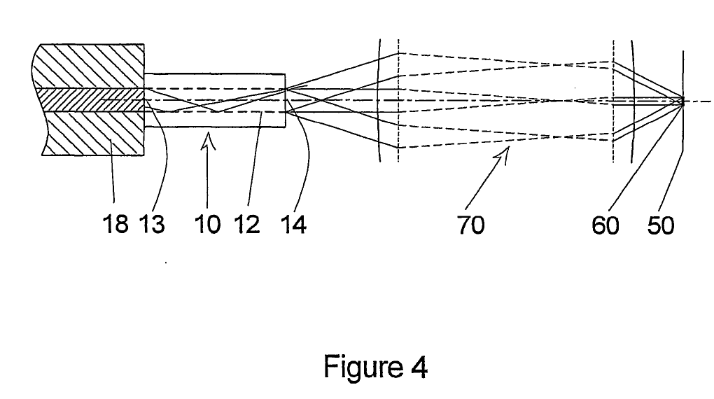

FIG. 4 schematically shows an optical imaging head incorporating a multi-mode fiber light source 18 and an MLP 10 (the supporting V-grooves are not shown). The exit aperture 14 of the MLP 10 is imaged by means of imaging lens 70 (preferably telecentric) on the photosensitive medium 50, i.e. the exit aperture 14 lies in the object plane of the imaging lens 70, while its image 60 lies on the photosensitive medium 50, which coincides with the lens 70 image surface. Due to the relatively uniform illumination of the exit aperture 14, as shown on FIG. 3b, the image 60 will also feature relatively uniform distribution of illumination. Thus, a very well defined spot is achieved on the medium 50.

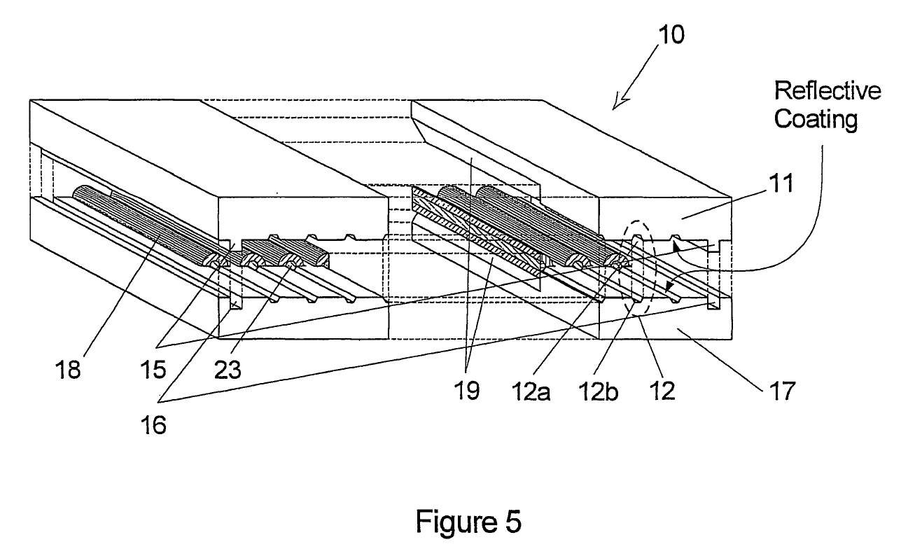

Reference is now made to FIG. 5, which is a schematic exploded view of an array of optical-fiber light sources with scrambling MLPs. The whole assembly 10 consists of upper and lower parts, 11 and 17 respectively. Arrays of precision V-grooves 19 are etched in both parts 11 and 17, supporting the optical fibers 18. The grooves 19 continue into MLPs 12. Each MLP 12 is formed by joining two halves 12a and 12b, also etched in the same upper and lower parts 11 and 17, respectively. The keys 15 and 16 enable precise alignment of the two parts 11 and 17. This construction allows the optical fibers' cores 23 to be circumscribed very precisely into the MLP's entrance apertures. The inner surface of the parts 11 and 17 is coated with a highly reflective coating, such as bare Au, enhanced Al, dielectric, etc., depending on the base material and the wavelength of the light.

It will be appreciated by any person skilled in the art, that the fiber supporting V-grooves and the light scrambling MLPs can be made as separate parts and later in the process of the assembling of the imaging system to be precisely aligned relative to each other, in order to obtained the desired position of the optical fiber relative to the MLP.

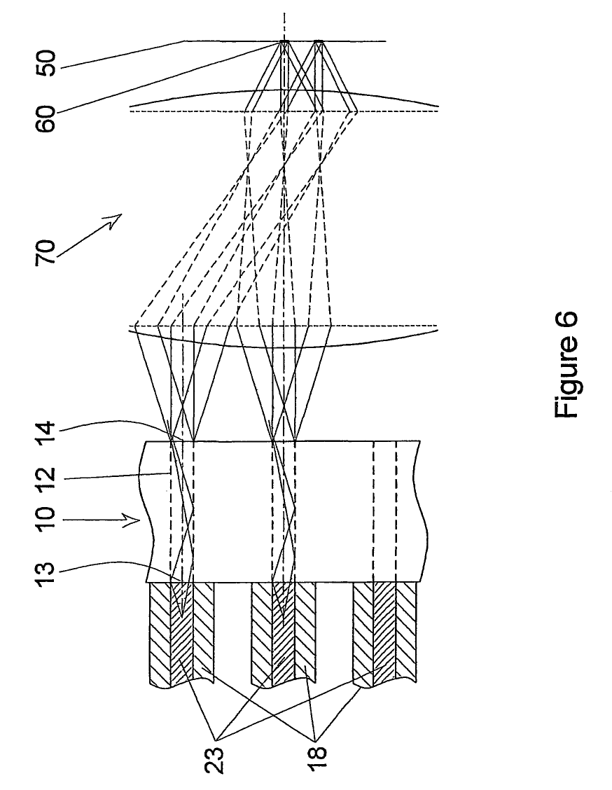

FIG. 6 schematically shows an optical imaging head incorporating an array of multi-mode optical-fiber sources 18 and an array of MLPs 10 (the supporting V-grooves are not shown). The exit apertures 14 of the MLPs 12 is imaged by means of imaging lens 70 (preferably telecentric) on the photosensitive medium 50, i.e. the exit apertures 14 of the MLPs 12 lie in the object plane of the imaging lens 70, while their images 60 lie on the photosensitive medium 50, which coincides with the lens 70 image surface. Due to the relatively uniform illumination of the exit apertures 14, as shown in FIG. 3b, the images 60 will also feature relatively uniform distribution of illumination Thus, very well defined spots are achieved on the medium 50.

PRODUCTION METHOD

Micro light-pipes and arrays of MLPs such as shown in FIGS. 2a, 2b and 5 can be produced by using standard photolithographic technologies on silicon wafers. The element consists of two basic plates 17 and 11, on which one or more V-grooves for supporting the optical fiber are etched, the V-grooves continuing into half-hexagonal grooves also etched in the same Si wafer. Here, etching along the Si [111] crystallographic planes is performed. This technology is well mastered in many companies around the world, for example in the Micro-Technology Institute in Mainz, Germany or MicroDevices Inc of Radford, Va.

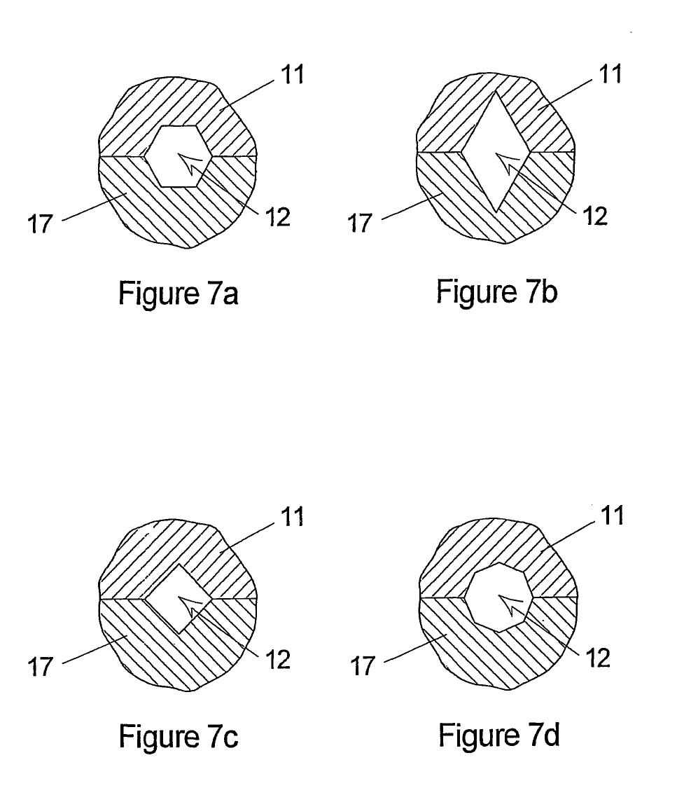

The grooved surfaces are coated with a highly reflective coating, for example enhanced Al or bare Au, depending on the light wavelength. The mechanical keys 15 and 16 are formed by the same photolithographic process and are used for easy alignment of the two parts 17 and 11. By etching along the same [111] crystallographic planes, a diamond-like shape can be achieved, as illustrated in FIG. 7b.

Other shapes can be achieved and other materials can also be used. For example, shapes as illustrated in FIGS. 7a, 7c and 7d, as well as non-symmetrical shapes can be made by the so called gray-scale photolithography, well mastered by companies like the same Micro-Technology Institute in Mainz, Germany and Rochester Photonics Corporation of Rochester, N.Y. Other than Si, materials including non-crystalline like glass, fused silica or polymers can also be used.

We claim:

1. An optical imaging head comprising:
a multi-mode laser diode optically coupled to a multi-mode optical fiber;
micromachined support for said optical fiber;
micromachined light-pipe (MLP) aligned with said support and with said optical fiber; and
means for imaging the exit aperture of said micro light-pipe on a photosensitive medium.

2. An optical imaging head according to claim 1 wherein said MLP surface is coated with a highly reflective coating.

3. An optical imaging head according to claim 2 wherein said coating comprises one of the group consisting of Au, Al and dielectric.

4. An optical imaging head according to claim 1 wherein said means for imaging comprises a telecentric lens.

5. Optical imaging head comprising:
an array of multi-mode laser diodes optically coupled to multi-mode optical fibers;
an array of micromachined supports for said optical fibers;
an array of micromachined light-pipes (MLPs) aligned with the said supports and with said optical fibers; and
means for imaging the exit aperture of each of said micromachined light-pipes on a photosensitive medium.

6. An optical imaging head according to claim 5 wherein said MLPs surfaces are coated with a highly reflective coating.

7. An optical imaging head according to claim 6 wherein said coating comprises one of the group consisting of Au, Al and dielectric.

8. An optical imaging head according to claim 5 wherein said means for imaging comprises a telecentric lens.

9. A method for creating a light spot on a photosensitive medium comprising the steps of:
providing a multi-mode laser diode coupled to a multi-mode optical fiber;
providing a support for said optical fiber,
providing a micromachined light-pipe aligned with said support and with said optical fiber; and
imaging the exit aperture of said micro-machined light-pipe on said photosensitive medium.

10. A method for creating a plurality of light spots on a photosensitive medium comprising the steps of:
providing an array of multi-mode laser diodes coupled to multi-mode optical fibers;
providing a support array for said optical fibers;
providing an array of micromachined light-pipes aligned with said support array and with said optical fibers; and
imaging the exit apertures of said micro-machined light-pipes on said photosensitive medium.
